(19) United States
(12) Patent Application Publication
(10) Pub. No.: US 2009/0064030 A1
(43) Pub. Date: Mar. 5, 2009

(54) System and Method For Representing Point-In-Time Data On A Common Viewing Plane

(76) Inventor: Suman Grandhi, Irvine, CA (US)

Correspondence Address: MINTZ, LEVIN, COHN, FERRIS, GLOVSKY AND POPEO, P.C, ONE FINANCIAL CENTER, BOSTON, MA, 02111, US

(21) Appl. No.: 12/131,880

(22) Filed: Jun. 2, 2008

Related U.S. Application Data
(60) Provisional application No. 60/932,675, filed on Jun. 1, 2007.

(51) Int. Cl. G06F 3/048

(52) U.S. Cl. 715/781

(57) ABSTRACT

A system and method for representing point-in-time data on a common viewing plane are presented. A representation of data is displayed in a display window of a graphical user interface. The representation includes two or more different representations of different versions of the data, each different version having a creation time and a last-modified time. A unique graphical element is applied to each different representation of the different versions of the data within the display window according to the creation time.

### CROSS REFERENCE TO RELATED APPLICATIONS

This application claims the benefit under 35 U.S.C. Section 119(e) of a provisional application U.S. Ser. No. 60/932,675, entitled “System and Method For Representing Point-In-Time Data On A Common Viewing Plane,” filed Jun. 1, 2007 (Attorney Docket No. 35084-502-PRO), which is incorporated by reference herein.

### BACKGROUND

This disclosure relates generally to data management, and more particularly to software that enables users to view temporal data in an intuitive manner.

It is currently very difficult to view a set of data from different points in time. Using conventional data protection software, different point-in-time versions have to be “recovered or restored” from a proprietary format into a native format. Even if the different point-in-time versions are readily useable as in a replication software, the process generally requires the traversal of several namespaces or paths, each representing a different point-in-time. As a result, to access data from different points in time requires multiple steps by a combination of user and computer.

### SUMMARY

In general, this document discusses a system and method for data management, and more particularly to a system and method for representing data from various points in time onto the same viewing plane.

According to one aspect, a computer implemented method includes the steps of displaying a representation of data in a display window, the representation including two or more different representations of different versions of the data. The method further includes the steps of applying a unique graphical element to each different representation of the different versions of the data within the display window. In some implementations, the unique graphical element can include color, shading, and/or graphical selector control, including a drop-down graphical selector control.

According to another aspect, a computer implemented method includes the steps of displaying a representation of data in a display window, the representation including two or more different representations of different versions of the data, each different version having a creation time and a last-modified time. The method further includes the steps of applying a unique graphical element to each different representation of the different versions of the data within the display window according to the creation time.

In yet another aspect, a system for representing point-in-time data on a common viewing plane includes a graphics generator that generates a graphical user interface in a display. The system further includes a window generator that generates a display window within the graphical user interface, the display window displaying a representation of data including two or more different representations of different versions of the data. The window generator is further adapted to apply a unique graphical element to each different representation of the different versions of the data within the display window.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIGS. 1-4 illustrate various aspects of a system and method for representing data from various points in time, using a common display view.

Like reference symbols in the various drawings indicate like elements.

### DETAILED DESCRIPTION

This document describes a system and process of graphically representing data from multiple points in time at the same time. Data that has been recorded at various points in time can be represented in a graphical manner that distinguishes old data from newer data. Because data from previous points in time can be represented in a uniquely identifiable graphical manner, old and new data can be displayed in the same viewing plane.

Such systems and techniques give the user a temporal view of a set of data. If the user chooses not to view previous versions of a data, then the display can collapse to show only a specific point-in-time version of the data. Thus, it is also possible to explicitly view only specific previous version or versions of the data. A global control could be added to specify a time range for which the data can be displayed for viewing. For example, the global control could be set to display data with points in time, i.e. from 1 to 10 days ago.

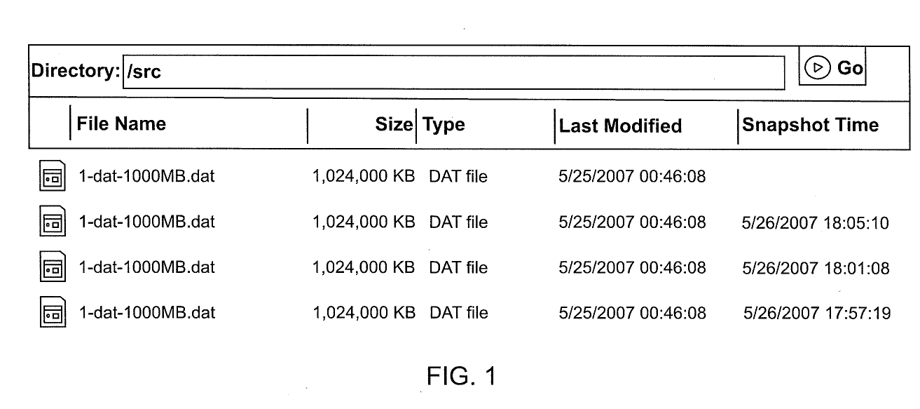

FIG. 1 illustrates one example, where the most current version of a set of data, “1-dat-1000MB.dat,” is displayed in a dark black font color. The previous versions of the same file are displayed in a grey font. The time and date of the captured data is displayed in addition to the last modified date. This allows the user to instantly recognize the most current version of the file. In addition, the user is able to recognize that there are multiple older versions of the same file.

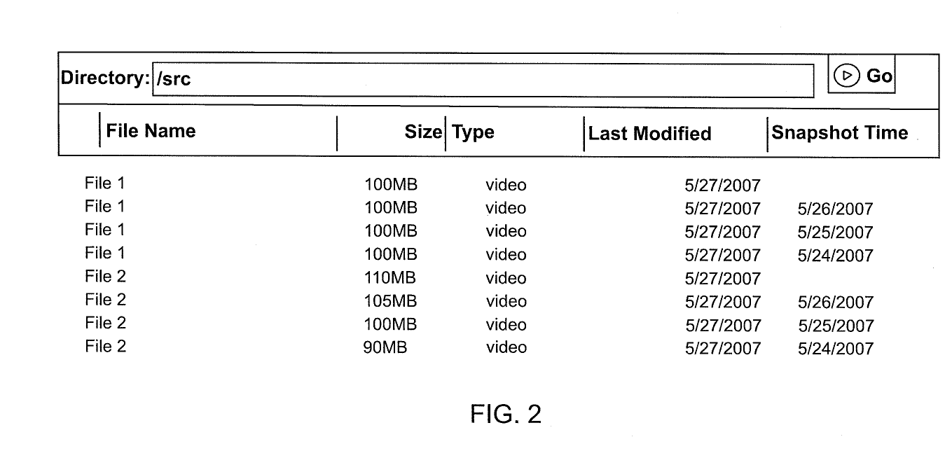

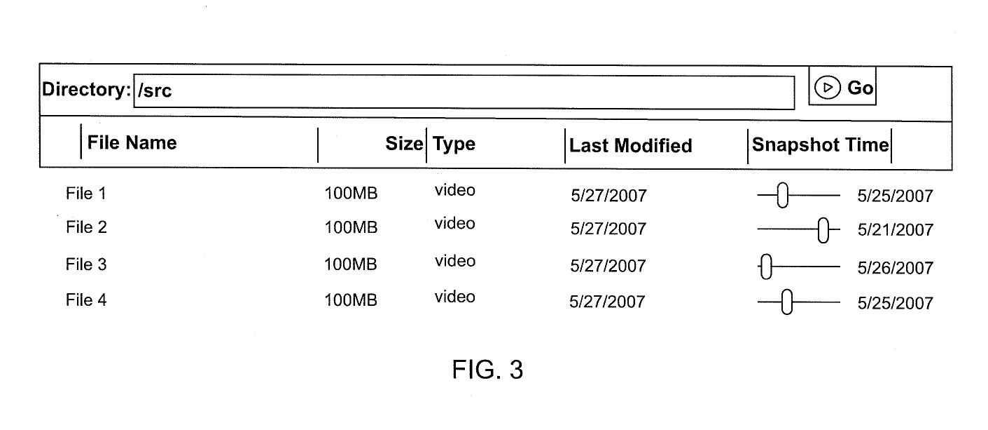

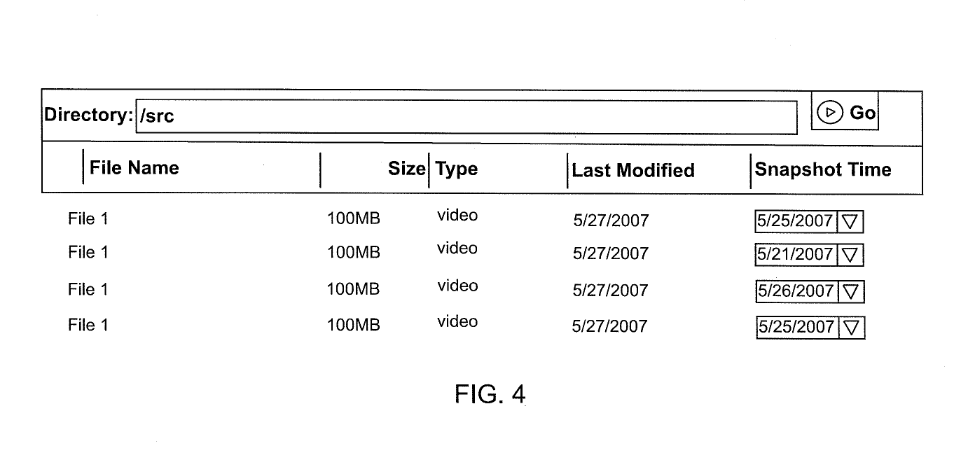

FIG. 2 represents another example in which older data is represented by an increasingly lighter font color. FIG. 3 represents yet another example, in which the user is presented with a slide control for each data. The slide control can be manipulated by the user to select the point-in-time version of the data he or she wishes to access. FIG. 4 represents still yet another example, in which the user is presented with a drop-down box. The drop-down box can be manipulated by the user to select the point-in-time version of the data he or she wishes to access. Accordingly, the techniques and graphical user interfaces described herein allow a user to view a set of data from different points in time, i.e. to view temporal data in a more intuitive manner.

Some or all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A computer implemented method, comprising:
displaying a representation of data in a display window, the representation including two or more different representations of different versions of the data; and
applying a unique graphical element to each different representation of the different versions of the data within the display window.

2. The method in accordance with claim 1, wherein the unique graphical element includes a color.

3. The method in accordance with claim 1, wherein the unique graphical element includes a shading.

4. The method in accordance with claim 1, wherein the unique graphical element includes a graphical selector control.

5. The method in accordance with claim 1, wherein the unique graphical element includes a drop-down graphical selector control.

6. A computer implemented method, comprising:
displaying a representation of data in a display window, the representation including two or more different representations of different versions of the data, each different version having a creation time and a last-modified time; and
applying a unique graphical element to each different representation of the different versions of the data within the display window according to the creation time.

7. The method in accordance with claim 6, wherein the unique graphical element includes a color.

8. The method in accordance with claim 6, wherein the unique graphical element includes a shading.

9. The method in accordance with claim 6, wherein the unique graphical element includes a graphical selector control.

10. The method in accordance with claim 6, wherein the unique graphical element includes a drop-down graphical selector control.

11. A system for representing point-in-time data on a common viewing plane, the system comprising:
a graphics generator that generates a graphical user interface in a display;
a window generator that generates a display window within the graphical user interface, the display window displaying a representation of data including two or more different representations of different versions of the data, the window generator further adapted to apply a unique graphical element to each different representation of the different versions of the data within the display window.

12. The system in accordance with claim 11, wherein the unique graphical element includes a color.

13. The system in accordance with claim 11, wherein the unique graphical element includes a shading.

14. The system in accordance with claim 11, wherein the unique graphical element includes a graphical selector control.

15. A system in accordance with claim 11, wherein the unique graphical element includes a drop-down graphical selector control.
